(19) United States
(12) Patent Application Publication
(10) Pub. No.: US 2008/0208761 A1
(43) Pub. Date: Aug. 28, 2008

(54) Secured transactional banner

(76) Inventors: Christopher P. Autry, London (GB); Gregory J. Jarrett, London (GB)

Correspondence Address: STETINA BRUNDA GARRED & BRUCKER, 75 ENTERPRISE, SUITE 250, ALISO VIEJO, CA, 92656, US

(21) Appl. No.: 11/709,592

(22) Filed: Feb. 22, 2007

(51) Int. Cl. G06Q 30/00

(52) U.S. Cl. 705/78; 705/26

(57) ABSTRACT

By providing user interface functionality on a banner served on a webpage hosted by a third party, it is possible to carry out a secure transaction without the user leaving the banner. This is achieved by providing content and transaction middleware which co-operates with a served banner to, in the first instance provide a customised advertising banner and then subsequently to provide user interfaces which allow payment and personal details to be retrieved and to provide confirmation of a purchase. The banner may be served over a mobile device and may also be served overlayed onto moving video on the webpage. This provides a much better user experience and also provides better likelihood of converted sales from banner advertising.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

This invention relates to methods and apparatus for interacting with a website user, selling via a website, or web-enabled mobile device and also to a computer program product stored on a computer readable medium and embodying the methods.

It is known to conduct secure transactions such as purchasing of goods or services, via a website. In order to carry this out, it is necessary to enter the vendor's website and to quite possibly move to a third party website such as worldpay or paypal, to complete the payment part of the transaction.

Whilst this type of transaction is becoming increasingly popular and has been shown to be technically effective, from a presentational and sales aspect, this arrangement has the highly undesirable feature that the transaction may only be conducted on the vendor's website. Thus, whilst a vendor may advertise on other websites using conventional techniques such as pop-up adverts or flash banners, as soon as the transaction is required to be completed it is necessary, using current technology, to divert the user to a different website. This is a significant barrier since users generally do not wish to be diverted to an alternative website.

### BRIEF SUMMARY

By providing a user experience which combines some aspects of webpage banner advertising and some aspects of website transaction technology, the invention provides banners which are able to complete a secure commercial transaction without redirecting a user to a different webpage.

Accordingly, in a first aspect of the invention there is provided a method of selling via a website comprising displaying a user interface on a portion of a webpage, providing a user interface operable to take details of a product or service to be purchased and to take payment for the product or service, and presenting the user interface as part of the said webpage such that the purchaser can complete a transaction entirely within the said user interface.

It will be appreciated that webpage may be considered in this context to encompass electronic displays of other types such as a webpage displayed on mobile devices, touch-screen billboards and interactive kiosks. The essential requirement is of a display which is able to display variable content and an associated user input facility such as a mouse/pointer combination or touchscreen capability.

In a further aspect, the invention provides a computer program stored on a computer readable medium which when executed on a computer server causes the server to display a user interface on a portion of a webpage, provide a user interface operable to take details of an product or service to be purchased and to take payment for the product or service, and present the user interface as part of the said webpage such that the purchaser can complete a transaction entirely within the said user interface.

The transaction may be a purchase transaction or may be a transaction such as a newsletter sign-up, a brochure request or a database search.

The user interface (typically a banner of some sort) is served from a content database and includes functionality allowing user input, such as searching for products for example. The back end system also provides an application programming interface (API) to provide product or service information from a vendor's back end database system or normal sales website.

The user interface typically is implemented in a web interactivity and animation platform such as a Macromedia Flash and may, for example, be displayed over a moving video image. Other alternatives are implementations in HTML or AJAX.

In preferred embodiments, the banner may vary with the context of the website in which it is displayed. For example, the banner may relate to a hotel reservation system when displayed adjacent a review of the corresponding hotel.

In further aspects, the invention provides a method of interacting with a website user comprising displaying a user interface as part of a webpage, taking personal details from the user via the user interface, storing the personal details in a transaction database, taking payment details from the user via the user interface, recording the payment details in the transaction database, passing the personal and payment details from the transaction database to an online payment service provider, receiving status information from the online payment service provider and adjusting the information displayed in the user interface dependent on the status information.

The invention also provides a transaction system comprising a content database, a transaction database, a web interface and a payment interface, wherein the content database holds content for display on a web page via the web interface and wherein the transaction database holds data relating to purchase of goods or services which are retrieved via a user interface forming part of the said content, the payment interface being arranged to conduct a payment transaction with a third party online payment provider, based on data held in the transaction database.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

FIG. 1 is a schematic block diagram of a transaction system in accordance with the invention; and

FIG. 2 is a schematic data flow diagram in accordance with the invention.

### DETAILED DESCRIPTION OF THE INVENTION

The description below describes a detailed implementation of a secure transactional banner which may be displayed on a website alongside other contents and which allows an entire transaction to be carried out using only the banner as a user interface. The banner is hosted on a third party site not related to the main website as is carried out at the moment, for example for advertising banners. The banner communicates securely with transaction processing middleware as described in detail below.

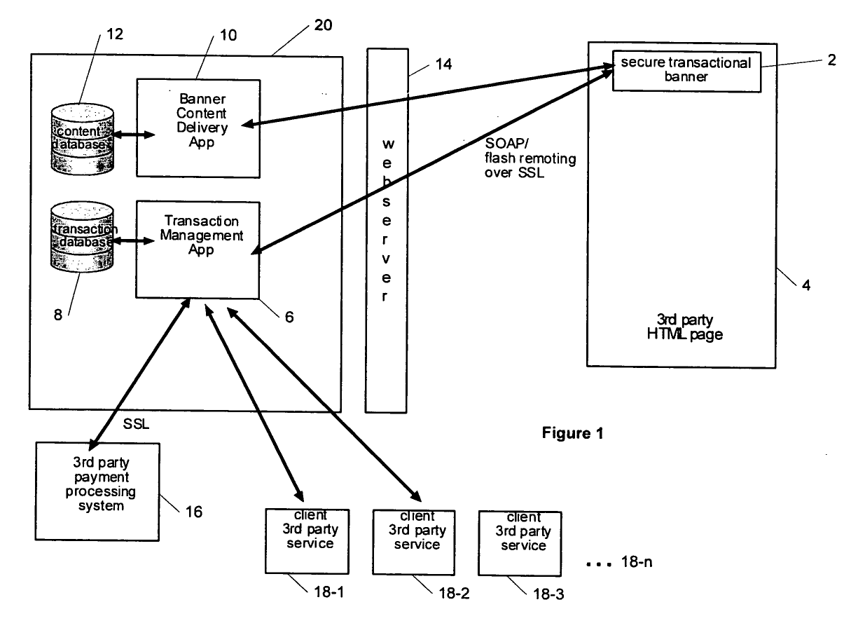

With reference to FIG. 1, the apparatus broadly comprises five components. Firstly, a secure transactional banner 2 is served on a third party HTML webpage 4. The webpage 4 maybe served on any HTML or WAP enabled device or any equivalents thereof such as a mobile device or personal computer.

Transaction processing middleware 6 and 8 manages the transaction with the user and banner content delivery middleware 10 and 12 selects the banner content and serves the content onto the webpage 4 using webserver 14.

The system also includes a third party payment processing system 16 and third party client services or product information 18-1, 18-2, 18-3, 18-n.

The banner 2 is a targeted banner served to a customer and offering the opportunity to engage in a secure transaction which takes place entirely in the screen space occupied by the banner and without redirecting the user's browser application to any other pages. Thus, the user may complete payment or fulfilment of the transaction without leaving the original webpage 4.

Typically, the transaction with the user involves the user first selecting a product or service to purchase, such as a hotel booking or donation to a charity. The banner then serves pages which allow entry of address details and further pages which allow entry of payment details such as credit or debit card details. Once these details are entered, they are passed to a conventional online payment system as described in more detail below, which returns status information concerning the transaction and which may then be displayed in the banner to provide feedback on success or failure of the transaction to the user.

The transaction is managed by a transaction management application 6. This is typically located on a server remote from that serving the webpage 4. This is the conventional model, for example for advertising banners. However, where advertising banners typically have limited functionality and no transactional functionality, a server 20, which contains the transaction management application provides the banner 2 with very significant and detailed functionality.

The transaction management application 6 stores and retrieves information from a transaction database 8. It also retrieves information on services or products to be sold through the banner 2 from third party service interfaces 18-1 to 18-n.

The transaction management application additionally co-ordinates with a banner content delivery application 10 in order to make appropriate changes to the user interface and product or service information on the secure transactional banner 2. The content is typically stored in a second database 12.

The banner content delivery application 10 and content database 12 form banner content delivery middleware. The middleware is responsible for deciding on the content of the banner, in co-ordination with the transaction management application 6. The decision may also be made based on the context in which the banner is displayed on the webpage 4. Thus, for example, the content in the banner 2 may be chosen by comparing keywords from the webpage 4 with mappings between keywords and suitable content, contained in the content database 12. For example, a hotel review webpage would pass the keywords hotel and the hotel name from the webpage 4 to the banner content delivery middleware which would in turn search the banner content database 12 to find matching banners advertising that hotel or hotels in the same chain, for example.

Typically, once the personal details such as address and delivery address and payment details have been collected in the transaction database, the transaction management application 6 co-ordinates with a third party payment processing system 16 to complete the transaction. The details are passed through the transaction processing middleware to the third party payment processing service where the details are validated and the payment transaction is completed. Status information flowing back from the third party payment processing system 16 is used by the transaction management application 6 and in co-ordination with the banner content delivery application 10 to provide status confirmation to the user via the banner 2.

The transaction management application 6 also co-ordinates with client third party services 18-1 to 18-n. These services provide information on products or services involved in the transaction. These may be third party services as shown in the figure or alternatively may be contained in a further database (not shown) in the server 20. Examples of third party services are checking hotel bookings or travel ticket availability or checking availability of product stock.

The transaction processing middleware provides a standardised API for the client third party services.

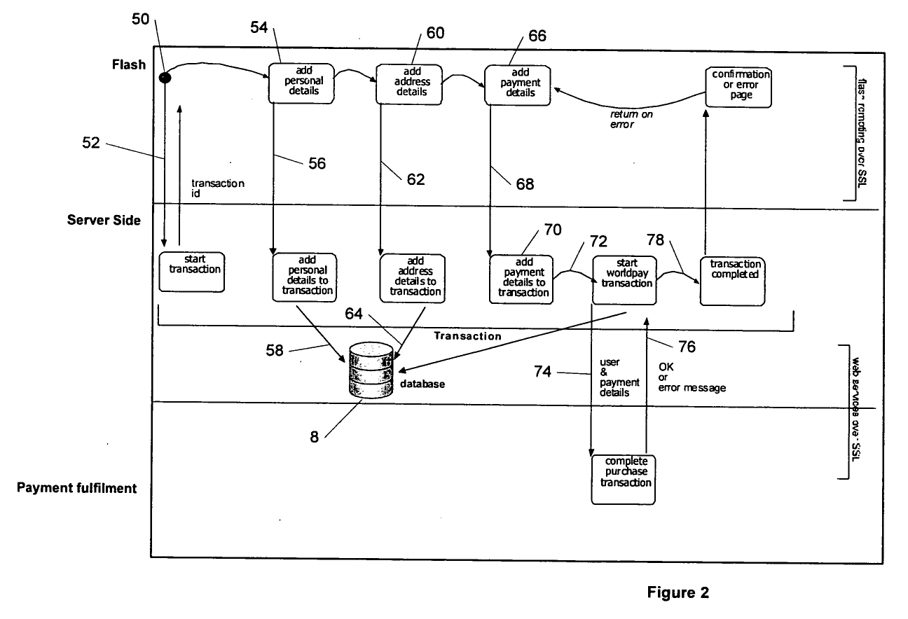

With reference to FIG. 2, a typical communication and dataflow during a transaction is shown.

In the upper part of the figure information is served on the third party webpage 4. In the middle part, activity occurs on the server 20 and in the lower part, activity occurs in the third party payment processing system 16.

For simplicity, details of retrieving products or services are not shown in this dataflow diagram. As noted above, that data may be held in the server 20 or may be accessed from third party services or indeed may be a hybrid of the two approaches.

With particular reference to FIG. 2, the diagram includes a time axis with increasing time elapsed moving from left to right in the figure. Thus on the far left, a flash application starts at position marked 50. This application is typically some form of advertising banner displayed on the webpage 4. It will be appreciated by the skilled person that flash is but one example of a platform suitable for implementing the invention. The essential requirements of the platform are the ability to display variable content, to receive user input and to pass input back to a predetermined server or the like.

At position 52, a user interacts with the banner 2 and requests commencement of a transaction. A secure sockets layer (SSL) connection is made back from the flash movie (for example using flash remoting over SSL or simple object access protocol (SOAP)) in order to start the transaction. The transaction management application returns with a transaction ID which is used to identify the transaction as information flows between the remote banner and the content and transaction middleware server 20 as described below.

At position 54, the content is changed to provide the user interface which requests entry of personal details such as address and delivery address for the service of goods. This information is retrieved by the banner 2 and passed back to the transaction management application 6 for storage in the transaction database 8. This occurs at step 56. In step 58, the information is stored in the database 8.

Similarly, steps 60 to 64 involve the recovery of address details from the user via the banner and steps 66 to 70 involve collection of payment information such as credit card information.

Once the credit card information is retrieved, this is used in step 72 to commence payment with a third party payment provided 16. The user and payment details are passed to the third provider 16 in step 74 and in step 76, status information is returned. The status information is then reflected (in step 78) in the provision of a confirmation or error page in the secure transactional banner. If there is an error then the payment details are re-entered by returning the state of the banner back to step 66.

As will be seen, this arrangement provides an easily implemented transactional banner. From the provider of the webpage 4's point of view the banner may be served in the same way as a conventional flash advertising banner. The additional functionality is provided by server 20 using the transaction and banner content middleware described above and in conjunction with secure communication provided between the banner 2 and the server 20.

Similarly, communications between the third party payment processing system 16 and the server 20 are carried out over an encrypted link using, for example, SSL and communications with third party servers provided 18-1 to 18-n may also be carried out over an encrypted link.

What is claimed is:

1. A method of transacting via a website comprising displaying a user interface on a portion of a webpage, providing a user interface operable to take details of a desired transaction such as a product or service to be purchased and to complete the transaction such as taking payment for a product or service, and presenting the user interface as part of the said webpage such that the user can complete a transaction entirely within the said user interface.

2. A method of transacting as claimed in claim 1, further including arranging for the user interface to allow a user to search for the said product or service using the user interface without leaving the said webpage.

3. A method of transacting as claimed in claim 1, further including obtaining information about a product or service from a third party source.

4. A method of transacting as claimed in claim 1, wherein the user interface is displayed over a moving video image within the said webpage.

5. A method of transacting as claimed in claim 1, including holding the details of the product or service to be purchased taken from the user and the corresponding payment details, in a secure transactional database and encrypting communications between the transactional database and the user interface.

6. A method of transacting as claimed in claim 5, including passing the details of the product or service to be purchased taken from the user and the corresponding payment details, from the transactional database to an online payment service provider.

7. A method of transacting as claimed in claim 1, wherein the content of the user interface is dependent on the content of the said webpage.

8. A computer program stored on a computer readable medium which when executed on a computer server causes the server to display a user interface on a portion of a webpage, provide a user interface operable to take details of a desired transaction such as a product or service to be purchased and to complete the transaction such as taking payment for the product or service, and present the user interface as part of the said webpage such that the user can complete a transaction entirely within the said user interface.

9. A computer program as claimed in claim 8, further including arranging for the user interface to allow a user to search for the a product or service using the user interface without leaving the said webpage.

10. A computer program as claimed in claim 8, further including obtaining information about a product or service from a third party source.

11. A computer program as claimed in claim 8, wherein the user interface is displayed over a moving video image within the said webpage.

12. A computer program as claimed in claim 8, including holding details of a product or service to be purchased taken from the user and the corresponding payment details, in a secure transactional database and encrypting communications between the transactional database and the user interface.

13. A computer program as claimed in claim 12, including passing the details of the product or service to be purchased taken from the user and the corresponding payment details, from the transactional database to an online payment service provider.

14. A computer program as claimed in claim 8, wherein the content of the user interface is dependent on the content of the said webpage.

15. A method of interacting with a website user comprising displaying a user interface as part of a webpage, taking personal details from the user via the user interface, storing the personal details in a transaction database, taking transaction details such as payment details from the user via the user interface, recording the transaction details in the transaction database, passing the personal and transaction details from the transaction database to an online transaction service provider such as a payment provider, receiving status information from the online transaction service provider and adjusting the information displayed in the user interface dependent on the status information.

16. A method as claimed in claim 15, further including arranging for the user interface to allow a user to search for the a product or service using the user interface without leaving the said webpage.

17. A method as claimed in claim 15, further including obtaining information about a product or service from a third party source.

18. A method as claimed in claim 15, wherein the user interface is displayed over a moving video image within the said webpage.

19. A method as claimed in claim 15, including holding the details of a product or service to be purchased taken from the user and the corresponding payment details, in a secure transactional database and encrypting communications between the transactional database and the user interface.

20. A method as claimed in claim 19, including passing the details of the product or service to be purchased taken from the user and the corresponding payment details, from the transactional database to an online payment service provider.

21. A method as claimed in claim 15, wherein the content of the user interface is dependent on the content of the said webpage.

22. A transaction system comprising a content database, a transaction database, a web interface and a transaction interface, wherein the content database holds content for display on in a predetermined user interface portion of a web page via the web interface and wherein the transaction database holds data relating to a transaction such as the purchase of goods or services which are retrieved via a user interface forming part of the said content, the transaction interface being arranged to conduct a transaction with a third party online transaction provider such as a payment provider, based on data held in the transaction database and the web interface being arranged to serve the user interface such that a user is able to complete a transaction entirely using the user interface.

23. A transaction system as claimed in claim 22, wherein the web interface carries encrypted communications.

24. A transaction system as claimed in claim 23 wherein the web interface is arranged to provide content translated for display on a mobile device and to receive user interface input via a mobile device.
